(19) United States
(12) Patent Application Publication
(10) Pub. No.: US 2006/0173977 A1
(43) Pub. Date: Aug. 3, 2006

(54) A PROCESS FOR DYNAMIC USER CONTROL ON ALWAYS-ON IP NETWORK

(75) Inventors: Sammy X. HO, Washington, DC (US); Jim FLUKIGER, Washington, DC (US)

Correspondence Address: SUGHRUE MION, PLLC, 2100 PENNSYLVANIA AVENUE, N.W., SUITE 800, WASHINGTON, DC, 20037, US

(73) Assignee: NEXT GENERATION BROADBAND, Washington, DC (US)

(21) Appl. No.: 11/275,875

(22) Filed: Feb. 1, 2006

Related U.S. Application Data
(60) Provisional application No. 60/649,135, filed on Feb. 3, 2005.

(51) Int. Cl. G06F 15/177

(52) U.S. Cl. 709/220

(57) ABSTRACT

A system and method for permitting an operator of a terminal device to switch from a first network to a second network without requiring a rebooting or resetting of the communication protocol system is disclosed. More specifically, filters present at the customer premise equipment (CPE) are configured to as to permit or block access to the respect first and second networks in response to configuration and setting information provided from a dynamic user control system and apparatus (DUCS). As a result, IP traffic is blocked or permitted in accordance with information from DUCS, so as to permit seamless switching between networks under conditions as warranted by a network operator.

### CROSS-REFERENCE TO RELATED APPLICATIONS

The present application claims the benefit of U.S. provisional application No. 60/649,135, entitled “Process for Dynamic User Control on Always-On IP Network”, filed on Feb. 3, 2005 in the United States Patent and Trademark Office, the disclosure of which is incorporated herein in its entirety by reference. This priority claim under 119(e) is being made concurrently with the filing of this application.

### BACKGROUND OF THE INVENTION

1. Technical Field

The exemplary embodiments described herein related to a method for dynamically controlling the services and applications an end user can receive, access, and use on an always-on Internet Protocol (IP) data network. More specifically, a network operator, from a central point in the network, can dynamically switch a user from one network-controlled application system to another network-controlled application system without requiring reboot or reset of a terminal device.

2. Related Art

In the related art, end users access network-based data services through customer premise equipment (CPE). The CPE is located, for example but not by way of limitation, at the domicile or place of business of the user. The related art network service, such as an always-on data service, is managed centrally, for example but not by way of limitation, from a data center. The related art data network service often extends from a few locations to a very large number of geographically disperse locations.

The related art CPE normally includes the user terminal and/or a bridging device. Exemplary CPEs include, but are not limited to, cable modems, digital subscriber line (DSL) modems, satellite modems, Fiber-to-the-x (FTTx, where x can be business, home or the like) optical terminals, and Media Terminal Adapters (MTAs).

Exemplary user terminal devices include, but are not limited, to personal computers, internet protocol (IP) enabled television set top boxes, and other IP-based devices that end users can employ to receive and transmit information, content and data.

Related art residential high speed internet access systems use either Dynamic Host Configuration Protocol (DHCP) or Point-to-Point Protocol (PPP) to configure the basic IP connectivity. When a CPE is activated, the CPE sends IP configuration requests to the network, and retrieves responses from the network. As a result, all of the network parameters in the CPE are configured, including, its assigned IP addresses and the IP addresses of various servers, such as domain name system (DNS) servers.

However, the related art has various problems and disadvantages. For example, but not by way of limitation, there is no related art method for a network operator to directly and dynamically control the end user's experience, such that the end user could be dynamically switched between the network operator's primary system and an alternate application system seamlessly.

Further, there is an additional burden in that the related art approaches to dynamic control of the user experience require the following:

1. the user must log into a proxy server;

2. there is unique hardware on the edge of the network; and

3. the client software is installed on the user's CPE.

For example, but not by way of limitation, if a user must have their internet access reduced due to a non-payment of a bill for said internet services, then the user must meet the foregoing requirements (e.g., logout and login, or reboot/reset the CPE) before the change of service that was already made on the server side can go into effect. Accordingly, the user may not immediately gain full internet access after payment of the bill, but instead, may have to reboot their terminal device as discussed above before the full internet access setting takes effect. Alternatively, an outside control system that is invasive (e.g., ActiveX) prompts the user to reboot. While ActiveX can reset the IP address or reboot the computer, Active X is a foreign program that lets a foreign, network service control the computer's action and contents.

Accordingly, there is an unmet need in the related art for a system that does not include the foregoing requirements.

### SUMMARY OF THE INVENTION

Illustrative, non-limiting embodiments of the present invention overcome the above disadvantages and other disadvantages not described above. Also, the present invention is not required to overcome the disadvantages described above, and illustrative, non-limiting embodiment of the present invention may not overcome any of the problems described above.

An exemplary embodiment of the present invention includes a system for controlling access to a network application, comprising customer premise equipment (CPE) coupled to an internet protocol (IP) network, a central system configured to provide access to an internet service provider (ISP) for said CPE, said central system coupled to said IP network, an application system coupled to said IP network, each configured to provide at least one IP service to said CPE, and a dynamic user control (DUC) system coupled to said IP network, wherein said DUC system is configured to dynamically switch a configuration of at least one filter of said CPE to control access with respect to said application system without requiring resetting of said CPE.

Also provided is a method of controlling access to a network application, comprising, in a network-based control service, determining whether a customer premise equipment (CPE) needs to be switched from a first network to a second network; if (a) said CPE requests an internet protocol (IP) address and (b) it is determined that said CPE needs to be switched from said first network to said second network, identifying said CPE based on a physical address of said CPE, associating said CPE with a first network application, said control service configuring filters of said CPU to restrict access to one of said first network and said second network, and permit access to another of said first network and said second network, wherein said configuring is performed without requiring a reset operation of said CPE.

Further provided is a computer readable medium including a set of instructions for controlling access to a network application, said instructions comprising: in a network-based control service, determining whether a customer premise equipment (CPE) needs to be switched from a first network to a second network; if (a) said CPE requests an internet protocol (IP) address and (b) it is determined that said CPE needs to be switched from said first network to said second network, identifying said CPE based on a physical address of said CPE, associating said CPE with a first network application, said control service configuring filters of said CPE to restrict access to one of said first network and said second network, and permit access to another of said first network and said second network, wherein said configuring is performed without requiring a reset operation of said CPE.

### BRIEF DESCRIPTION OF THE DRAWINGS

The exemplary embodiment will be better understood from the detailed description below, in consideration of the non-limiting, explanatory drawing figures which are now briefly described.

FIG. 1 illustrates a system according to an exemplary, non-limiting embodiment of the present invention.

FIG. 2 illustrates a process according to the exemplary, non-limiting embodiment of the present invention.

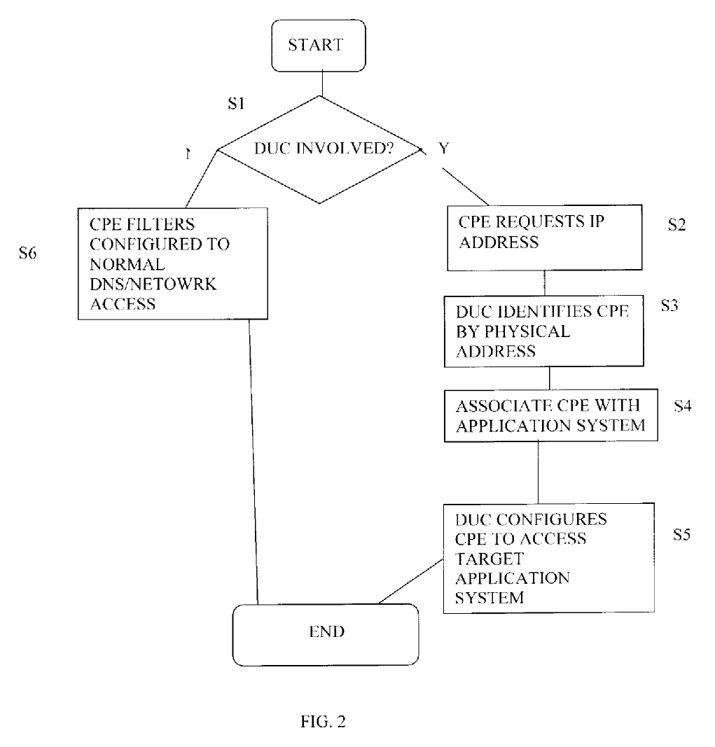

### DETAILED DESCRIPTION OF THE EXEMPLARY EMBODIMENTS

Hereinafter, the exemplary embodiment will be described in detail with reference to the attached drawings.

An exemplar embodiment of the present invention is known as Dynamic User Control (DUC), which is configured such that a Network Operator can dynamically control network based services that are being received by the user's terminal device.

DUC permits the network operator to control the applications and network services that the end user may access at any time. DUC achieves this functionality by augmenting the existing IP Address Server's capabilities to identify the CPE by its Media Access Control (MAC) address and determining if the CPE has permission (i.e., rights) to access a specific application system. If the CPE has permission to access a specific application system DUC enables the IP Address Server to request the DUC Application (DUCA) to configure the CPE to enable access to only the target application system. For example, but not by way of limitation, the IP Address Server may be a DHCP server.

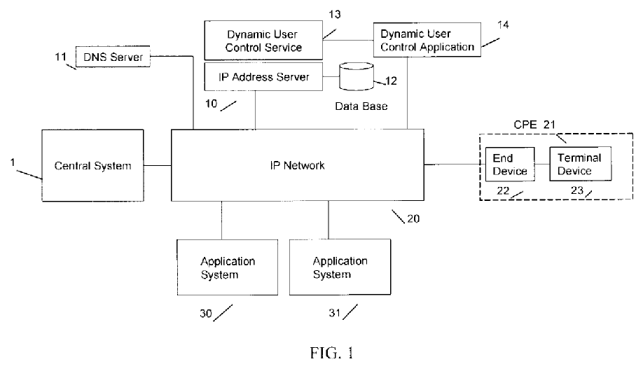

FIG. 1 illustrates the DUC system according to an exemplary, non-limiting embodiment of the present invention, Central System 1 includes network services and systems required that permit Internet Server Provider (ISP) access. The Central System 1 includes, but is not limited to, an IP Address Server 10, a billing system a customer management system, content, and Internet Access.

IP Address Server 10 provides a temporary IP Address lease to end devices or terminal devices. A non-limiting example of the IP Address Server is a DHCP server.

DNS Server 11 is configured to resolve host computer names and addresses, such as uniform resource locators (URLs) or uniform resource identifiers (URIs), into IP Addresses. Database 12 is used by the IP Address Server 10 as a reference to determine the status, access rights and permission for devices requesting IP address.

The Dynamic User Control Service (DUCS) 13 is an application that operates cooperatively with IP Address Server 10 to determine if a specific device belongs with the network operator's server or with the application system 30, 31.

DUCA 14 is a separate software application that includes a workflow engine (or control service) 13, a data storage device 12, an IP Address Server 10 (e.g., DHCP), a special DNS Server (DNS Application Redirector, or DAR) 11, and other elements. DUCA 14 uses IP communication protocols to dynamically configure CPE devices and network elements, and to link to other application systems.

Dynamic User Control Application (DUCA) 14 operates cooperatively with DUCA 13. Based on instructions from DUCS 13, DUCA 14 configures CPE 21 and IP network 20 based on specific business rules, as are well-known by those skilled in the art. More specifically. DUCA 14 determines the Quality of Service/routing path. For example, but not by way of limitation, such business rules may be considered analogous to policy-based categorization, such as policy based queuing that is based on quality of service (QoS) or the like. Moreover, IP Network 20 commonly couples elements of the central system 1, applications system 30, 31 and the end device 22 together.

The CPE includes 21 includes the end device 22 and the terminal device 23. End device 22 couples the network to the end user's home or office. Examples of end devices include, but are not limited to, DSL modems, cable modems, and satellite modems. The terminal device 23 is used by the end user to access network based services and content. Examples of terminal devices include, but are not limited to, personal computers, personal digital assistants (PDAs), and digital set top boxes. Application system 30, 31 may include application or network services that operate as a peer with respect to the Central System 1. The application system 30, 31 is network service that operates as a pear to the Central System 1.

DUC is installed at a network operator's data center, and coupled to the operator's network. At a high level, the exemplary embodiment includes DUCS 13 and DUCA 14. DUCS 13 works as an extension of the network operator's DHCP server (IP Address Server 10).

DUCS 13 and DUCA 14 perform at least the following functions. When CPE 21 requests and/or renews an IP address (using for example a DHCP request), DUCS 13 determines the type and the hardware address of the CPE 21. Based on this information, DUCS 13 determines if the CPE 21 is associated with a specific DUCA 14 function or policy. Further, based on the business rules. DUCS 13 determines the application system 30, 31 with which the CPE 21 is associated, and updates that application system as to the status of the CPE 21. If the CPE 21 is not associated with any application system, then DUCS 13 passes the CPE's DHCP request through, and does not have any effect on the CPE's IP access.

If the CPE 21 is selected by DUCS 13 based on defined set of business rules, DUCS 13 instructs DUCA 14 to configure the CPE 21 such that IP traffic to specific 11P addresses in the IP network 20 is blocked through the use of the filters that are already present on the CPE 21. In addition, DUCA 14 can configure selected components in the IP network 20 to accomplish the substantially same function.

For example but not by way of limitation. DUCA 14 can configure an access control list on a router in the IP network 20 to enable or block traffic from a specific CPE's IP address for a specific session or period of time. Additionally. DUCA 14 includes the DNS Application Redirector (DAR), e.g., DNS server 11. This is an alternate DNS server, which resolves WWW domain names to the IP addresses or DUCA web servers, which provide alternate web applications that control the user's access and experience.

When the CPE 21 receives its IP Address, the IP Address Server 10 is configured to send multiple DNS addresses including the IP Address for DNS servers (DARs) associated with the target application system 30, 31. In the DNS protocol, when the first DNS cannot be reached, the CPE 21 automatically tries to reach the second DNS. Accordingly, under normal operation the CPE 21 is configured to permit access to the network operator's DNS server and to block access to the DUCA's DNS server 11.

When a CPE 21 is determined to be associated with the application system 30, 31, the CPE 21 is configured to block access to the network operator's DNS server 11 and to permit traffic to flow to the application system's DNS server, and its target web applications. As a result, the end user's experience can be controlled, and the application system 30, 31 can be configured to identify the end user based on the CPE's hardware address, and thus personalize the user's experience based on the operator's needs and requirements.

DUC may be implemented as a software application (e.g., a set of instructions resident in a computer-readable medium or data carrier as would be understood by one of ordinary skill in the art) that operates cooperatively with two or more DNS Servers. The two or more DNS servers include a first, general DNS server, such as those in the related art, and a second, specially configured DNS server, called the DNS Application Redirector (DAR).

The DNS Application Redirector (DAR), e.g., the DNS server 11, allows requests for IP applications, such as web pages, to be redirected to alternate applications. Serving up responses to these requests is substantially dependent on DNS resolution of domain names (for example, but not by way of limitation, a web site such as www.mycompany.com). The exemplary embodiment of the present invention allows the name resolution function to be directed to the DAR. The DAR resolves domain names to the respective IP addresses of servers that provide DUC applications.

An aspect of the exemplary embodiment directed to a system in which DUC operates will now be described. The exemplary embodiment can be integrated into the system environment for a typical network operator. A network operator that provides a wide-area network (WAN) that enables users to access IP network and application services includes (among others):

1. CPE network access devices, such as a cable modems;

2. WAN;

3. IP Address Services systems for providing IP configuration information to client devices (e.g., DHCP);

4. DNS Servers for domain name to IP address resolution;

5. OSS (Operational Support Systems) for network, account, user maintenance; and

6. Application servers, such as web servers, mail servers, etc.

A specific example of an implementation of DUC is now described. This specific example relates to a cable modem network. In the cable modem network, DUCA dynamically configures the cable modem (i.e., the CPE) by setting its filters such that the cable modem and downstream CPE access only the target application system. In this specific example, existing IP filters of the CPE are set by an application system to control network devices, including the cable modem. The cable modem represents one of a number of possible devices that could be used. Other devices that could be used as the CPE include, but are not limited to, routers, DSL modems, and wireless modems.

Additionally. IP Filters are used to control the flow of IP traffic in the cable modem. For example but not by way of limitation, an IP) filter may block or enable IP traffic with respect to a specific IP address, or a range of IP) addresses.

DUC may be associated with one or more unique network-based application systems. Examples of application systems may include, but are not limited to, new activations, pre-paid high-speed data services, as well as content delivery and control systems.

An exemplary, non-limiting operation process of the DUC system will now be described. First, it is determined whether the DUC is involved at operation S1. The condition under which the DUC would be involved is described above, and can include, for example but not by way of limitation, the situation where there is a new activation of an account or a change in account access.

If it is determined in operation S1 that the DUC is to be involved, then the following operations may proceed. When a CPE 21 requests an IP address in operation S2. DUC works in conjunction with the IP Address Server 10 to identify the CPE 21 by its physical (i.e., hardware or MAC) address at operation S3.

After DUC has identified the CPE's physical address, identified the (PE 21, and associated that CPE 21 with one of the DUC applications in operation S4. DUC configures the filters in the associated CPE 21 such that the terminal device downstream from the CPE may only access the target application. This configuration is achieved by (1) setting the CPE filters such that only a specific DNS server can be accessed, and/or (2) setting the CPE filters such that access to specific IP addresses is blocked. In FIG. 29 this is referred to as operation S5. In the foregoing operations, the CPE 21 can be switched from a first network to a second network without requiring a reset operation at the CPE 21.

As a result or the foregoing operations, the end user experience is thus controlled by IP filters so as to enable access only to a specific and controlled set of DNS servers, which are part of the DUC system, and which perform the DAR function. The function of the DAR results in the direction of the user's IP network application requests to a given DUC application.

On the other hand, when it is determined in operation S1 that DUC has no involvement, the CPE's filters are configured to allow normal DNS and network access, as shown in operation S6. DUC may also be implemented at a hardware appliance that operates in cooperation with IP Address servers and DNS servers.

It is noted that the foregoing operations may be performed in the system illustrated in FIG. 1 and described above, and that the various operations may be performed in a computer readable medium, a data carrier, or similar media as would be understood by one of ordinary skill in the art. Alternatively, as also disclosed herein, various ones of the foregoing operations may also be performed in hardware.

An exemplary implementation of the foregoing process will now be described. In this exemplary process, a user logs into a terminal device 23 such as, but not limited to, a personal computer. The terminal device may be on a network service that does not require the user to tog on, but may instead permit user authentication through the physical address of their CPE 21.

The CPE 21 thus requests an IP address from Central System 1. The Central System's IP Address Server 10 recognizes that CPU 21 as a valid device. DUCS 13, which is installed on the IP Address Server 10, checks the physical address of the CPE 21 and identifies the CPE 21 as belonging to a parallel application system 30, 31.

The Dynamic User Control Service 13 instructs DUCA 14 to set filters at the CPE 21 such that IP traffic such as DNS queries can only access the designated application system 30, 31. In addition. IP traffic to specific servers such as the DNS server for the Central System 1 can be blocked. Further, the network can be configured to block traffic to destinations such as but not limited to an email server or Internet access gateway.

When Central System 1 provides the IP Address and configuration to the end device 22, the Central System 1 provides locations for the DNS server 11 associated with the Central System 1, as well as the IP address for DNS servers associated with other application system 30, 31.

When the terminal device 23 attempts to resolve a host name or web address, the request can only reach the application system 30, 31 and its associated DNS server 11. Subsequently, application can, through techniques such as IP address spoofing, can control what the servers and the terminal device 23 receives.

The CPE 21 can be associated with the Central System 1 by instructing DUCA to reset the CPE 21 filters to block traffic to the application system 30, 31 and permit traffic to Central System 1 and its elements. No rebooting or resetting of the terminal device 23 is required.

The exemplary embodiments of the present invention have various advantages. However, other advantages or no advantages at all may be achieved without departing from the scope of the invention.

For example, but not by way of limitation. DUC allows a network operator to centrally control the applications and services that an end user can receive, without having to force the end user to reboot or restart their terminal device. The end user's experience is managed and controlled by the application system. More specifically, the settings of the end device ensure that application traffic is directed to the appropriate application system that the end user's web browsing is controlled, and content that the Operator wants presented is delivered. As a result, the network operator can take immediate action to control the end user in a manner that is seamless to the user.

Further, contrary to the example in the related art, according to the exemplary embodiment, once a user pays a bill online and the internet access has been restored, DUC shifts the user to a parallel network without requiring rebooting as the filters in the CPE are switched in accordance with routing and configuration information that is set in and received from the DUCA.

While the present invention has been particularly shown and described with reference to exemplary embodiments thereof, it will be understood by those of ordinary skill in the art that various changes in form and details may be made therein without departing from the spirit and scope of the present invention as defined by the following claims.

I/We claim:

1. A system for controlling access to a network application comprising:
customer premise equipment (CPE) coupled to an internet protocol (IP) network;
a central system configured to provide access to an Internet service provider (ISP) for said CPE, said central system coupled to said IP network;
an application system coupled to said IP network each configured to provide at least one IP service to said CPE; and
a dynamic user control (DUC) system coupled to said IP network, wherein said DUC system is configured to dynamically switch a configuration of at least one filter of said CPE to control access with respect to said application system without requiring resetting of said CPE.

2. The system of claim 1, said DUC system comprising:
a DUC service that determines whether said CPE is associated with said application system based on at least one of a type and a physical address of said CPE;
a DUC application that generates a configuration and provides said configuration to said CPU and said IP network in accordance with said determination of said DUC service, and based con a set of business rules;
an IP address server that generates a temporary IP address to said CPE; and
a domain name system (DNS) server configured to resolve at least one of a host name and a host address into an IP address.

3. The system of claim 2, wherein said IP address server is coupled to a database that provides information of at least one of a status and an access right off said CPE with respect to said IP address.

4. The system of claim 1, wherein said DUC application generates said configuration in accordance with a Media Access Control (MAC) address of said CPE.

5. The system of claim 1, said CPE comprising:
an end device that coupled said IP network to a location of an end user; and
a terminal device that is used by said end user to access services of said IP network.

6. The system of claim 1, wherein said CPE comprises a cable modem having said al least one filter configured to block or enable IP traffic with respect to an IP address and said IP network comprises a cable modem network.

7. The system of claim 1, wherein said DUC system is positioned in one of a hardware device and a computer-readable medium as software.

8. A method of controlling access to a network application, comprising:
in a network-based control service, determining whether a customer premise equipment (CPE) needs to be switched from a first network to a second network:
if (a) said CPE requests an internet protocol (IP) address and (b) it is determined that said CPE needs to be switched from said first network to said second network;
identifying said CPE based on a physical address of said CPE,
associating said CPE with a first network application,
said control service configuring filters of said CPE to restrict access to one of said first network and said second network, and permit access to another of said first network and said second network, wherein said configuring is performed without requiring a reset operation of said CPE.

9. The method of claim 8, said determining further comprising determining whether said CPE is associated with an application system based on at least one of a type and said physical address of said CPE, and said generating further comprising generating a configuration and providing said configuration to said CPE and said network application in accordance with said determination, and based on a set of business rules;

10. The method of claim 8, wherein an IP address server that generates a temporary IP address to said CPE, and a domain name system (DNS) server resolves at least one of a host name and a host address into an IP address.

11. The method of claim 8, wherein said physical address comprises a Media Access Control (MAC) address of said CPE.

12. The method of claim 8, said CPE comprising:
an end device that coupled said IP network to a location of an end user; and
a terminal device that is used by said end user to access services of said IP network.

13. The method of claim 8, wherein said CPE comprises a cable modem having said at least one filter that blocks or enables IP traffic with respect to an IP address, and said IP network comprises a cable modem network.

14. The method of claim 8, wherein said configuring is performed by one of (a) setting said filters of said CPE to only access a specified domain name server (DNS), and (b) setting said filters of said CPE to block access to a specified IP address.

15. A computer readable medium including a set of instructions for controlling access to a network application, said instructions comprising:
in a network-based control service, determining whether a customer premise equipment (CPE) needs to be switched from a first network to a second network;
if (a) said CPE requests an internet protocol (IP) address and (b) it is determined that said CPE needs to be switched from said first network to said second network,
identifying said CPE based on a physical address of said CPE.
associating said CPE with a first network application,
said control service configuring filters of said CPE to restrict access to one of said first network and said second network, and permit access to another of said first network and said second network, wherein said configuring is performed without requiring a reset operation of said CPE.

16. The computer readable medium of claim 15, said determining further comprising determining whether said CPE is associated with an application system based on at least one of a type and said physical address of said CAP, and said generating further comprising generating a configuration and providing said configuration to said CPE and said network application in accordance with said determination, and based on a set of business rules;

17. The computer-readable medium of claim 15, wherein an IP address server that generates a temporary IP address to said CPE, and a domain name system (DNS) server resolves at least one of a host name and a host address into an IP address.

18. The computer readable medium of claim 15, said CPE comprising:
an end device that coupled said IP network to a location of an end user; and
a terminal device that is used by said end user to access services of said IP network.

19. The computer readable medium of claim 5, wherein said CPE comprises a cable modem having said at least one filter that blocks or enables IP traffic with respect to an IP address, and said IP network comprises a cable modem network.

20. The computer readable medium of claim 15, wherein said configuring is performed by one of (a) setting said filters of said CPE to only access a specified domain name server (DNS), and (b) setting said filters of said CPE to block access to a specified IP address.
